(19) United States
(12) Patent Application Publication
(10) Pub. No.: US 2012/0298226 A1
(43) Pub. Date: Nov. 29, 2012

(54) Modular Heating and/or Cooling System with a Vertical Manifold and Method of Making Same

(76) Inventor: Jake Jared Struempler, Anchorage, AK (US)

(21) Appl. No.: 13/430,559

(22) Filed: Mar. 26, 2012

Related U.S. Application Data
(60) Provisional application No. 61/467,235, filed on Mar. 24, 2011.

(51) Int. Cl. F16L 41/00

(52) U.S. Cl. 137/561 A

(57) ABSTRACT

A heating/cooling manifold is presented. The manifold includes a first segment configured to vertical mount to a surface. The first segment comprises a first end and a second end, each comprising a coupling configured to releasably attach to a second segment; and between 2 and 4 ports disposed along the length of the first segment. The spacing between adjacent ports is less than 4 times an interior diameter of the first segment. The manifold further includes a second segment releasably attached to the first segment.

### CROSS-REFERENCE TO RELATED APPLICATIONS

This application incorporates by reference and claims priority to the U.S. Provisional Application Ser. No. 61/467,235, which was filed on Mar. 24, 2011.

### TECHNICAL FIELD

The present invention relates to a vertical manifold for a heating and/or cooling system and, more particularly, to a heating and/or cooling system with a one or more vertical manifold segments, where additional segments can be added or subtracted as needed for a given application and, most particularly, to a heating and/or cooling system with a one or more vertical manifold segments that can provide heated or cooled fluid for multiple commercial or residential purposes, such as producing hot water, floor heating or cooling, radiant heating, and snow melting.

### BACKGROUND ART

Many commercial and residential heating and/or cooling systems use a liquid heat transfer medium to provide heating and/or cooling for a number of different applications, such as, producing hot water, floor heating or cooling, radiant heating, and snow melting. A number of different liquid heat transfer mediums are used in these heating and/or cooling systems. These liquids include water, or if freezing is a concern, water mixed with an antifreeze, such as glycol. These heating and/or cooling systems also include a means to heat the liquid heat transfer medium. Such means may include, for example, a gas-fired boiler, a solar water heater, or a geothermal pump. These heating and/or cooling systems may also include a manifold and control system to support multiple heating and/or cooling zones. The control system monitors the temperature at each zone and directs the flow of the liquid heat transfer medium to achieve the pre-determined temperature setting for each zone. The liquid heat transfer medium is circulated through each zone through tubes or pipes, which act as heat exchangers to transfer heat between the heat transfer medium and the target location, such as a baseboard, flooring material, wall material, air in an enclosed space, or a driveway. Heating and/or cooling systems also include one or more pumps to circulate the heated liquid heat transfer medium through the system to provide a consistent source of heat to the target locations.

A closed-loop system is one type of heating and/or cooling system. In a closed-loop system, a fixed amount of a liquid heat transfer medium is sealed in a closed loop. The liquid heat transfer medium is continuously recirculated through the system by one or more pumps. The movement of the heat transfer medium carries heat to or from a heat exchanger, depending on the specific application and mode of operation (i.e., heating or cooling). Because the heat transfer fluid is sealed in the closed loop, a closed loop system can use a wider variety of heat transfer fluids than “open loop” systems, which generally use water.

A primary-secondary system is another type of heating and/or cooling system, which contain two distinct, but connected, loops: a primary loop and a secondary loop. In a primary-secondary system, a liquid heat transfer medium, usually water, is circulated in each loop. The loops, which intersect for a short span, are in fluid communication with each other. A heating source, often a gas fired boiler, heats the heat transfer liquid in the primary loop. A pump circulates the heat transfer fluid in the primary loop at a constant flow rate. A second pump circulates the heat transfer liquid in the secondary loop at a variable rate, determined by the heating required at the target location. The intersection of the secondary and primary loops is sized to allow various flow rates in the secondary loop without affecting the flow through the primary loop. By allowing the unobstructed flow of liquid around the primary loop, a primary secondary system avoids obstructing the flow of fluid to the boiler regardless of the flow in the second loop(s), and avoiding the dangerous situation that occurs when the liquid overheats, which is typically due to obstructions that occur and interrupt the flow of liquid back to the boiler.

The orientation and length of the intersection between the loops in a primary-secondary system are arranged to create hydraulic separation between the loops. Because hydraulic separation prevents the flow in one loop from interfering with the flow in the other loop, each loop may be treated independently as a stand-alone loop and designed accordingly. Hydraulic separation is often accomplished by a set of closely spaced tees attached to the primary loop. The tees must be no farther apart than 4 times the internal diameter of the primary loop pipe. As a result of the close spacing, the pressure drop between the tees along the primary loop is nearly zero. Because there is no pressure drop, the flow along the primary loop will not induce a flow within the secondary loop; flow in the secondary loop will only develop when a pump on the secondary loop is active.

Heating and/or cooling systems that employ a liquid heat transfer medium generally use a manifold to direct the fluid to various part of the system. Manifolds generally have one primary port and a plurality of secondary ports. Depending on the placement of the manifold in the system, the heat transfer fluid may flow in the primary port and out the plurality of secondary ports. Alternately, the heat transfer fluid may flow in the plurality of secondary ports and out in the primary port.

Manifolds are generally required for any heating and/or cooling system that is being used for more than one purpose or has more than one zone. For example, a system that is used to heat water for domestic use and for radiant floor heating requires a manifold to channel the heat transfer fluid to each destination. Similarly, a system used for multi-zone radiant floor heating requires a manifold to channel the heat transfer fluid to each zone.

Each system generally has a minimum of two manifolds. One manifold feeds heat transfer fluid into each zone (i.e., the supply manifold), while the other manifold accepts the fluid returning from the zones (i.e., the return manifold). Traditional manifolds are designed for horizontal installation. As such, a typical installation has the supply manifold mounted parallel with and adjacent to the return manifold. The horizontal length of the overall manifold installation increases with the number of supported zones, and has the potential to occupy a significant amount of wall space. In spaces with limited wall space, such as boiler rooms, crowded equipment rooms, or domestic laundry rooms, there may be insufficient wall space for the horizontal manifold installation necessary for the required zones.

Sediment and air have the potential to collect in manifolds. To remove the sediment, traditional manifolds must be drained and flushed. To remove the air, an air eliminator must be installed. However, with traditional horizontal manifolds, gas pockets have the potential to form and become trapped at various locations along the manifold's horizontal length, impacting system performance. As such, traditional manifolds must be periodically flushed to eliminate gas pockets.

Traditional manifolds have other limitations. Many traditional manifolds are designed to be a fixed length, which require intrusive and costly retrofits to adapt to different heating and/or cooling needs over time. Also, space restrictions often limit the ability to expand horizontal manifolds. Additionally, traditional manifolds are generally designed to accept only one source of heat. Addition heat sources may, at best, require intrusive and costly system redesigns and, at worst, not be possible due to system limitations.

As such, it would be an advance in the state of the art to provide a manifold designed to be vertically mounted, with an integrated air and sediment elimination mechanism, capable of interfacing with multiple heat sources, and with a modular design capable of supporting many different heating/cooling system configurations and capable of adapting to different needs over time by accepting additional sections and/or heat sources.

### BRIEF DESCRIPTION OF THE DRAWINGS

The invention will be more fully understood by referring to the following Detailed Description of Specific Embodiments in conjunction with the Drawings, of which:

FIG. 1 is a schematic of one embodiment of Applicant's invention in a primary-secondary loop configuration with two heating/cooling sources and four zones;

FIG. 2 is a reconfiguration of the embodiment of FIG. 1;

FIG. 3 is a schematic of one embodiment of Applicant's invention in a closed loop configuration with eight zones;

FIG. 4 is a schematic of one embodiment of Applicant's invention in a series primary loop configuration with three heating/cooling sources and six zones;

FIG. 5(a)-5(d) is a schematic of the individual segments of one embodiment of Applicant's invention;

FIG. 6 is a schematic of the horizontal coupling component of one embodiment of Applicant's invention;

FIGS. 7(a) and 7(b) is a schematic of the coupling and mounting bracket of one embodiment of Applicant's invention;

FIG. 8(a) is a schematic of the end view of one segment of one embodiment of Applicant's invention;

FIG. 8(b) is a schematic of a bracket, which is disposed between two segments of Applicant's invention;

FIGS. 9(a) and 9(b) are drawing depicting various installation and configuration options of Applicant's invention; and

FIG. 10 is a flowchart describing one embodiment of a method to make Applicant's vertical manifold.

### DETAILED DESCRIPTION OF SPECIFIC EMBODIMENTS

This invention is described in preferred embodiments in the following description with reference to the FIGs., in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

This invention is described in preferred embodiments in the following description with reference to the FIGs., in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

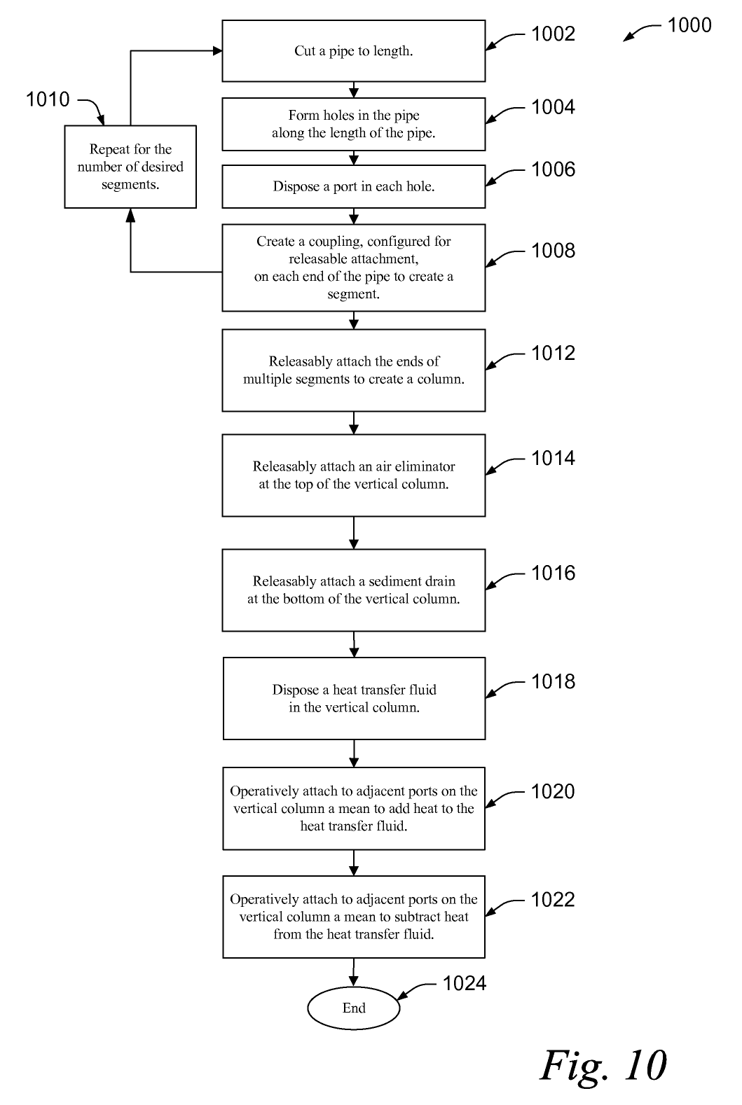

The schematic flow chart diagrams included are generally set forth as logical flow-chart diagrams (e.g., FIG. 10). As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method (e.g., FIG. 10). Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

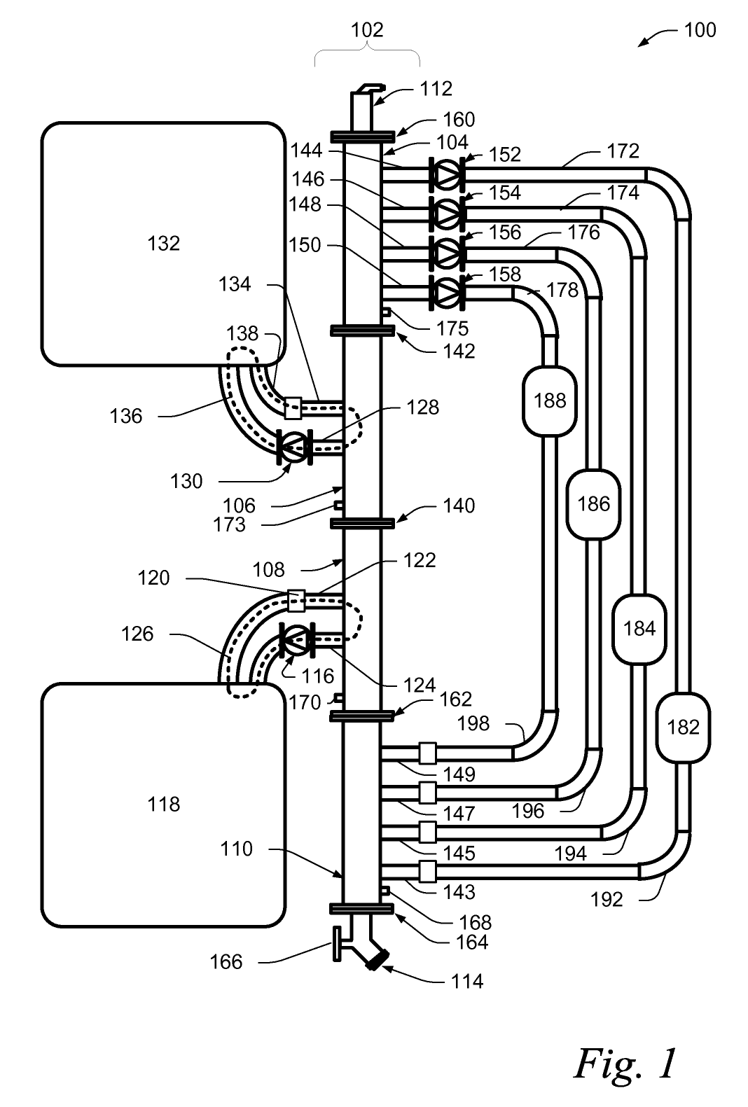

Referring to FIG. 1, a heating/cooling system 100 having a primary-secondary loop configuration using one embodiment of Applicant's vertical manifold is depicted. The vertical manifold 102 comprises two 4-port segments 104 and 110, two 2-port segments 106 and 108, an air eliminator 112, and a sediment drain 114. In different embodiments, the body of segments 104, 106, 108, and 110 are comprised of copper, brass, cross-linked polyethylene/aluminum/cross-linked polyethylene (PEX-al-PEX), polybutylene, polyethylene, or steel. In one embodiment, the body of segments 104, 106, 108, and 110 have a internal diameter of 1.5 inches. Each segment has two or more ports. In one embodiment, each port is within a distance of 4 times the internal segment diameter of each adjacent port, spaced along the length of a segment. This spacing creates hydraulic separation between the flow through the adjacent ports and the flow through the length of the vertical manifold 102.

A heat transfer fluid circulates through the heating/cooling system 100. In one embodiment, the heat transfer fluid is water. In one embodiment, the heat transfer fluid is ethylene glycol. In one embodiment, the heat transfer fluid consists of a mixture of water and ethylene glycol equal to or between a 50/50 to 60/40 glycol-to-water ratio. In one embodiment, the heat transfer fluid is hydrocarbon oil, such as synthetic hydrocarbons, paraffin hydrocarbons, or aromatic refined mineral oils. In one embodiment, the heat transfer fluid is a class 1, class 2, or class 3 refrigerant. In one embodiment, the heat transfer fluid is silicon-based.

A circulator pump 116 pumps a heat transfer fluid from the lower port 124 on the 2-port segment 108 of the vertical manifold 102, through a heating/cooling unit 118, out an outlet 120, and into the upper port 122 on the 2-port segment 108. The heating/cooling unit 118 heats or cools the passing heat transfer fluid to a specified temperature. In one embodiment, the heating/cooling system 100 can be used for heating applications, such as for home heating, producing hot water, or snow melting. In one embodiment, the heating/cooling system 100 can be used for cooling application, such as residential floor cooling. In different embodiments, 118 is a conventional cast-iron boiler, a solar heating unit, a bio mass heating unit, a geothermal heating unit, a heat pump, a gas furnace, or equivalents thereof for heating the heat transfer fluid. In different embodiments, 118 is an evaporative cooler, a heat pump, or refrigeration unit, or equivalents thereof for cooling the heat transfer fluid.

The circulation of the heat transfer fluid by circulator pump 116 creates a secondary loop 126 (shown by the broken line) through the heating/cooling system 100. The lower port 124 and upper port 122 are closely spaced to provide hydraulic separation between the secondary loop and the primary loop, which runs substantially through the length of the vertical manifold 102. Hydraulic separation allows fluid in the primary loop to flow independently of fluid in the second loop 126.

A circulator pump 130 pumps a heat transfer fluid from the lower port 128 on the 2-port segment 106 of the vertical manifold 102, through a second heating/cooling unit 132, out an outlet 138, and into the upper port 134 on the 2-port segment 106. The heating/cooling unit 132 heats or cools the passing heat transfer fluid to a specified temperature.

The circulation of the heat transfer fluid by circulator pump 130 creates a secondary loop 136 (shown by the broken line) through the heating/cooling system 100. The lower port 128 and upper port 134 are closely spaced to provide hydraulic separation between the secondary loop and the primary loop, which runs substantially through the length of the vertical manifold 102. Hydraulic separation allows fluid in the primary loop to flow independently of fluid in the second loop 136.

The 2-port segment 106 and 2-port segment 108 are releasably attached at coupling 140. The 4-port segment 104 is releasably attached to 2-port segment 106 at coupling 142. An air eliminator 112 is releasably attached to 4-port segment 104 at coupling 160. The second 4-port segment 110 is releasably attached to 2-port segment 108 at coupling 162. A sediment drain 114 is releasably attached to 4-port segment 110 at coupling 164. Each segment 104, 106, 108, and 110 has a port 168, 170, 173, and 175, respectively. In one embodiment, ports 168, 170, 173, and 175 receive a sensor for an integrated control system. In one embodiment, ports 168, 170, 173, and 175 receive a gauge to measure the flow, temperature, or other conditions within the respective segment. In one embodiment, ports 168, 170, 173, and 175 are plugged. In one embodiment, some ports receive a sensor and/or some ports receive a gauge, and/or some ports are plugged. In one embodiment, the ports 168, 170, 173, and 175 are ½ inch NPT Tappings.

The inner diameters of 2-port segments 106 and 108 and 4-port segments 104 and 110 create a continuous vertical column through the vertical manifold 102. During operation, heat transfer fluid flows through the continuous vertical column. Gravity forces any particulate matter in the hydraulic fluid transfer down toward the sediment drain 114, where it naturally gathers over time. The sediment drain 114 can be opened using handle 166 to flush the collected sediment from the heating/cooling system 100. Similarly, air or other gas trapped or dissolved in the heat transfer fluid will often form bubbles and rise up towards the air eliminator 112. The air eliminator 112 is configured to allow accumulated gas to escape while retaining the heat transfer fluid. In one embodiment, the inner diameter 124 of the segments 104, 106, 108, and 110 are sized such that fluid traveling through the vertical manifold 102 is sufficiently slow to allow particulate matter to settle to the sediment drain 114 and gas bubbles to rise to the air eliminator 112. In one embodiment, the inner diameter is 1.5 inches and the spacing between each port is 6 inches.

A zone circulator pump 152, 154, 156, and 158 is attached to each of the ports 144, 146, 148, and 150 on the 4-port segment 104. In one embodiment, the ports 144, 146, 148, and 150 have a threaded nipple. The zone circulator pumps 152, 154, 156, and 158 have internal threading and receive the threaded nipple on the ports 144, 146, 148, and 150. The zone circulator pumps are threadedly coupled to the ports 144, 146, 148, and 150.

Zone circulator pumps 152, 154, 156, and 158 draw heat transfer fluid from the 4-port segment 104 and drive the fluid into each zone feed line 172, 174, 176, and 178, through a heat transfer module 182, 184, 186, and 188, through zone return lines 192, 194, 196, and 198, and into ports 143, 145, 147, and 149 on the 4-port segment 110.

The configuration for the heating/cooling system 100 shown in FIG. 1 has four heating/cooling zones. Each zone comprises a zone feed line (172, 174, 176, 178), a heat transfer module (182, 184, 186, 188), and a zone return line (192, 194, 196, 198). This configuration supplies heat transfer fluid at the same temperature to each zone at ports 144, 146, 148, and 150.

The collective action of the zone circulator pumps 152, 154, 156, and 158 create a primary loop, which runs up the vertical manifold 102 at segment 104, through the individual zones, and back into the vertical manifold 102 at segment 110.

The heat transfer modules 182, 184, 186, and 188 transfer heat out of (in the case of heating) or into (in the case of cooling) the heating/cooling system 100. In different embodiments, the heat transfer module 182, 184, 186, and 188 are under-floor radiant heating or cooling loops. In one embodiment, one or more of the heat transfer module 182, 184, 186, and 188 is an indirect fired hot water heater. In one embodiment, one or more of the heat transfer modules 182, 184, 186, and 188 is a radiant baseboard heater.

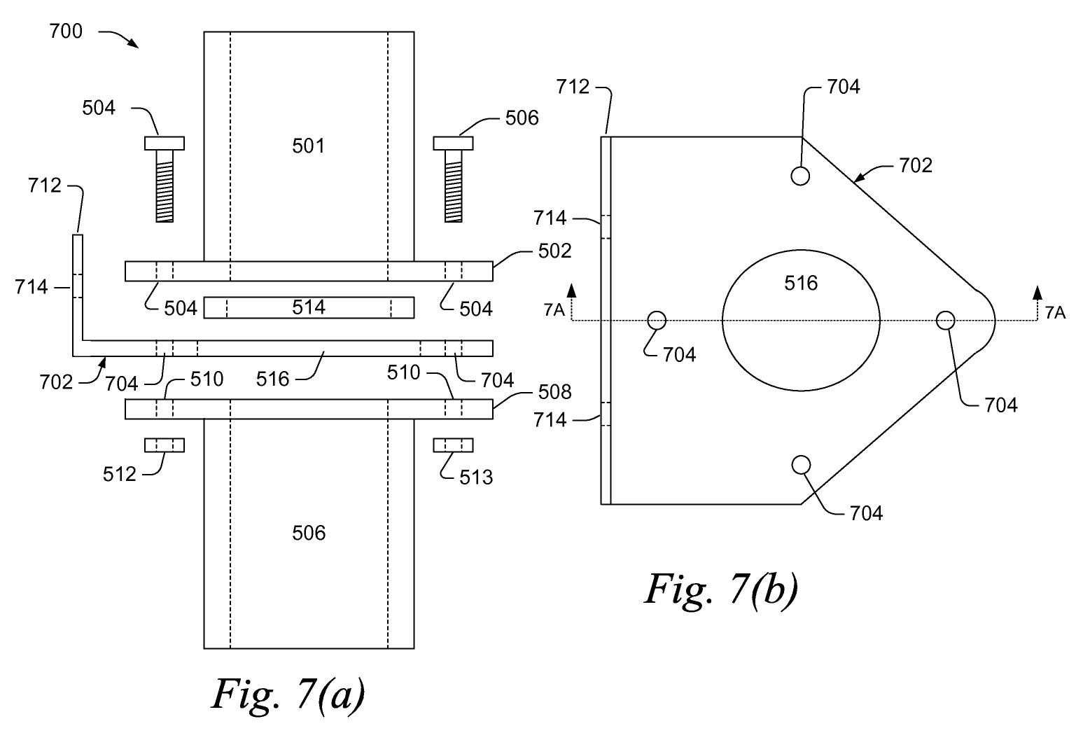

Each segment coupling 160, 142, 140, 162, and 164 provides a liquid and pressure seal between the attached segments. Each segment coupling 160, 142, 140, 162, and 164 is detachable, which allows the entire heating/cooling system 100 to be easily rearranged, reconfigured, or expanded as needed to accomplish the desired heating or cooling application. For example, the heating/cooling system 100 may be expanded to include a third heating or cooling unit or an additional set of 4-port segments to provide an additional four heating or cooling zones. In one embodiment, the segment couplings 160, 142, 140, 162, and 164 are constructed as depicted in FIG. 7(a) and described below. In one embodiment, the segment couplings 160, 142, 140, 162, and 164 include threaded pipe couplings configured to threadedly attach to the end of two segments, each segment having a threaded nipple. In one embodiment, the segment couplings 160, 142, 140, 162, and 164 include pipe clamps configured to secure the end of two segments by encircling and gripping a small flange at the end of each segment.

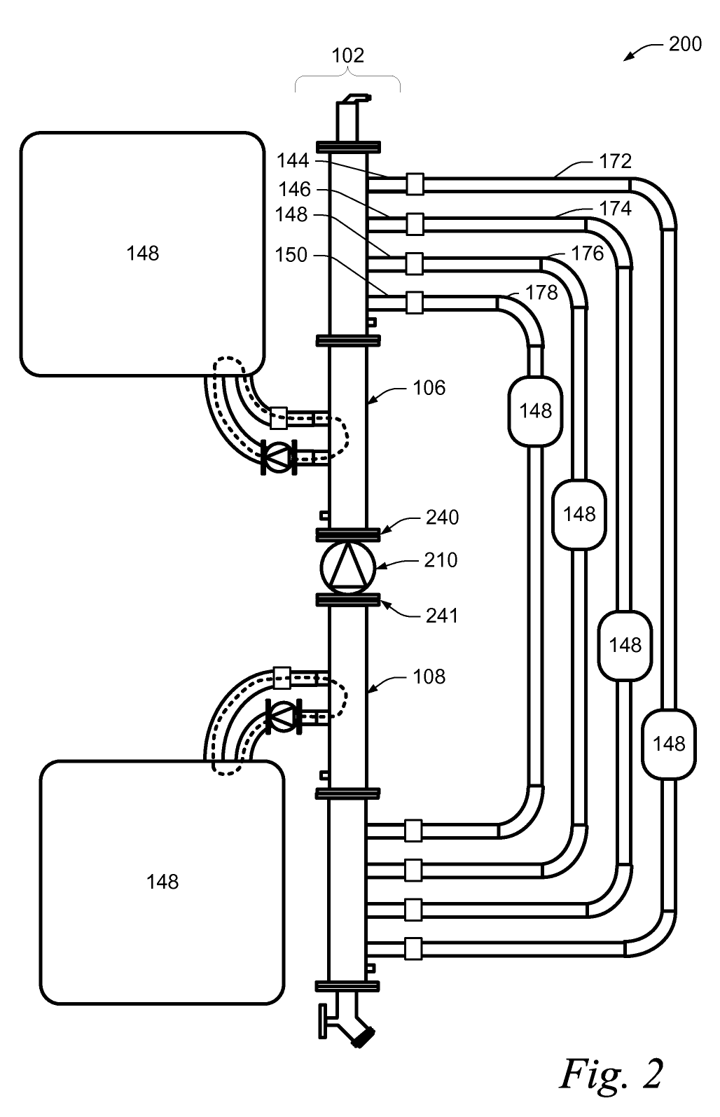

Referring to FIG. 2, a heating/cooling system 200 is depicted. The heating/cooling system 200 is a reconfiguration of the heating/cooling system 100 of FIG. 1. The zone circulator pumps 152, 154, 156, and 158 (in FIG. 1) have been removed and replaced with a single circulator pump 210. The circulator pump 210 circulates the heat transfer fluid up through the vertical manifold 102 and through each heating/cooling zone starting at ports 144, 146, 148, and 150.

The modular nature of the vertical manifold 102, allowed the embodiment of FIG. 1 to be easily reconfigured into the embodiment of FIG. 2. The zone circulator pumps 152, 154, 156, and 158 are detached from the ports 144, 146, 148, and 150 and from the zone feed lines 172, 174, 176, and 178. The zone feed lines 172, 174, 176, and 178 are then threadedly coupled to ports 144, 146, 148, and 150. 2-port segment 106 is detached from 2-port segment 108 at coupling 140 (in FIG. 1). Circulator pump 210 is releasably attached to 2-port segment 108 at coupling 241, releasably attached to 2-port segment 106 at coupling 240, and configured to pump fluid up through vertical manifold 102.

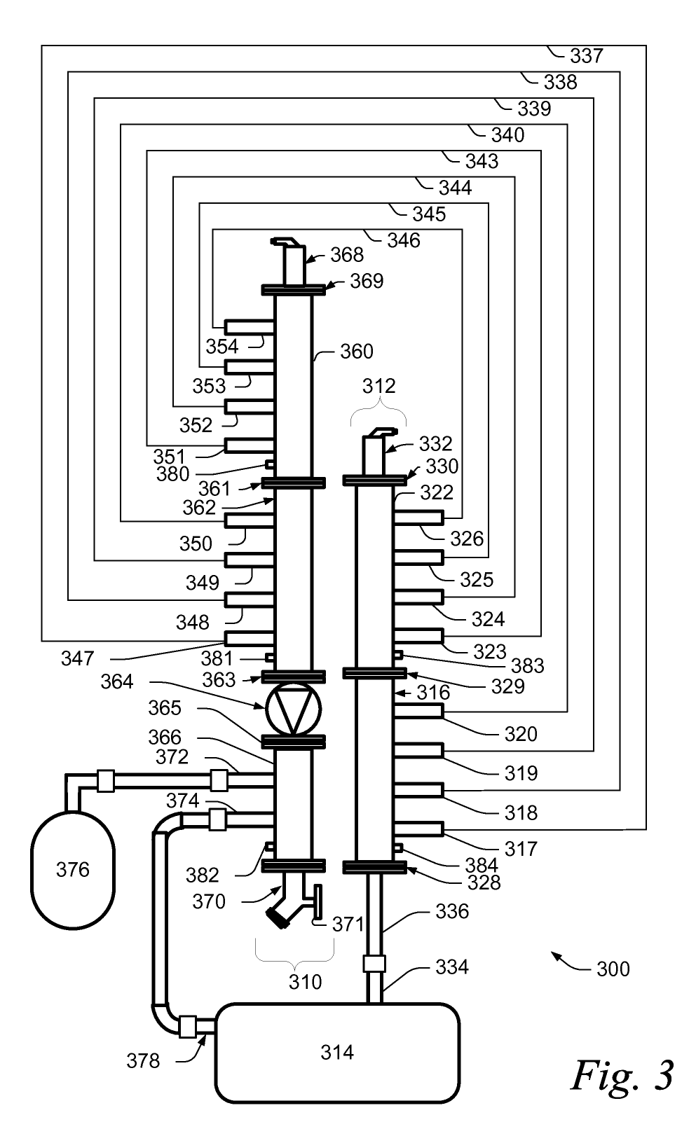

Referring to FIG. 3, a heating/cooling system 300 having a closed-loop configuration using one embodiment of Applicant's vertical manifold is depicted. The heating/cooling system 300 includes a supply column 312 and a return column 310.

The heating/cooling unit 314 heats or cools a heat transfer fluid to a specified temperature. In one embodiment, the heating/cooling system 300 can be used for heating applications, such as for home heating, producing hot water, or melting snow. In one embodiment, the heating/cooling system 300 can be used to for cooling application, such as residential floor cooling. In different embodiments, 314 is a conventional cast-iron boiler, a solar heating unit, a bio mass heating unit, a geothermal heating unit, a heat pump, a gas furnace, or equivalents thereof for heating the heat transfer fluid. In different embodiments, 314 is an evaporative cooler, a heat pump, or refrigeration unit, or equivalents thereof for cooling the heat transfer fluid. To better describe the invention and for purposes of clarity only, the heating/cooling system 300 will be hereinafter described as a heating system. As such, the heating/cooling unit 314 will be described as a boiler 314, which heats the heats transfer fluid.

A connector segment 336 is releasably attached to the output port 334 on the boiler 314. The connector segment 336 is releasably attached to 4-port segment 316 at coupling 328. 4-port segment 316 is releasably attached to 4-port segment 322 at coupling 329. 4-port segment 322 is releasably attached to air eliminator 332 at coupling 330.

4-port segment 316 has supply ports 317-320 and 4-port segment 322 has supply ports 323-326. Each supply port 317-320 and 323-326 supplies heated heat transfer fluid to heating zones 337-340, and 343-346. In this embodiment, the temperature of the heat transfer fluid provided to each heating zone is the same. In one embodiment, each zone uses heating fluid of the same temperature. In another embodiment, as will be understood by those of ordinary skill in the art, the mixing valves may be added to one or more zones to lower the temperature for the given zones in the event that different temperatures are required.

In one embodiment, each zone 337-340 and 343-346 includes a heat transfer module (not shown). One or more of the zones 337-340 and 343-346 may include a pump (not shown) to help circulate the heat transfer liquid through the given zone.

Air eliminator 368 is releasably attached to 4-port segment 360 at coupling 369. 4-port segment 360 is releasably attached to 4-port segment 362 at coupling 361. 4-port segment 360 has supply ports 351-354 and 4-port segment 362 has supply ports 347-350. The cooled heat transfer fluid from Each zone 337-340 and 343-346 is fed back into the return column 310 through return ports 347-350 and 351-354.

The 4-port segment 362 is releasably attached to circulator pump 364 at coupling 363. In one embodiment, the circulator pump 364 drives the heat transfer fluid down the return column 310, through the boiler 314, and through the zones 337-340, 343-346. The circulator pump 364 is releasably attached to 2-port segment 366 at coupling 365. The 2-port segment has ports 372 and 374. Port 374 is attached to the inlet port 378 of boiler 314. An expansion tank 376 is attached to port 372. An expansion tank is a small tank used in closed-loop heating systems to absorb excess pressure caused by thermal expansion of the heat transfer fluid or by fluid hammer, which is a pressure wave propagating through the heat transfer fluid.

The 2-port segment 366 is releasably attached to sediment drain 370. The inner diameters of 4-port segments 322 and 316 create a continuous vertical column through the vertical manifold 312. Likewise, the inner diameters of 4-port segments 360, 362, and 2-port segment 366 create a continuous vertical column, interrupted only by circulator pump 364, through the vertical manifold 310. Under the proper flow conditions, gravity will force particulate matter down vertical manifold 310 and toward the sediment drain 370, where it naturally gathers over time. The sediment drain 370 can be opened using handle 371 to flush the collected sediment from the vertical manifold 310. Similarly, air or other gas trapped or dissolved in the heat transfer fluid will often form bubbles and rise up towards air eliminators 332 and 368. Air eliminator 332 and 368 are configured to allow accumulated gas to escape while retaining the heat transfer fluid. In one embodiment, the internal diameter of each segment 360, 362, 366, 322, and 316 are sized such that fluid traveling through the vertical manifolds 310 and 312 is sufficiently slow to allow particulate matter to settle to the sediment drain 370 and gas bubbles to rise to the air eliminators 368 and 332. In one embodiment, the inner diameter of each segment 360, 362, 366, 322, and 316 is 1.5 inches.

Each segment 360, 362, 366, 322, and 316 has a port 380, 381, 382, 383, and 384, respectively. In one embodiment, ports 380, 381, 382, 383, and 384 receive a sensor for an integrated control system. In one embodiment, ports 380, 381, 382, 383, and 384 receive a gauge to measure the flow, temperature, or other conditions within the respective segment. In one embodiment, ports 380, 381, 382, 383, and 384 are plugged. In one embodiment, some ports receive a sensor and/or some ports receive a gauge, and/or some ports are plugged. In one embodiment, the ports 380, 381, 382, 383, and 384 are ½ inch NPT Tappings.

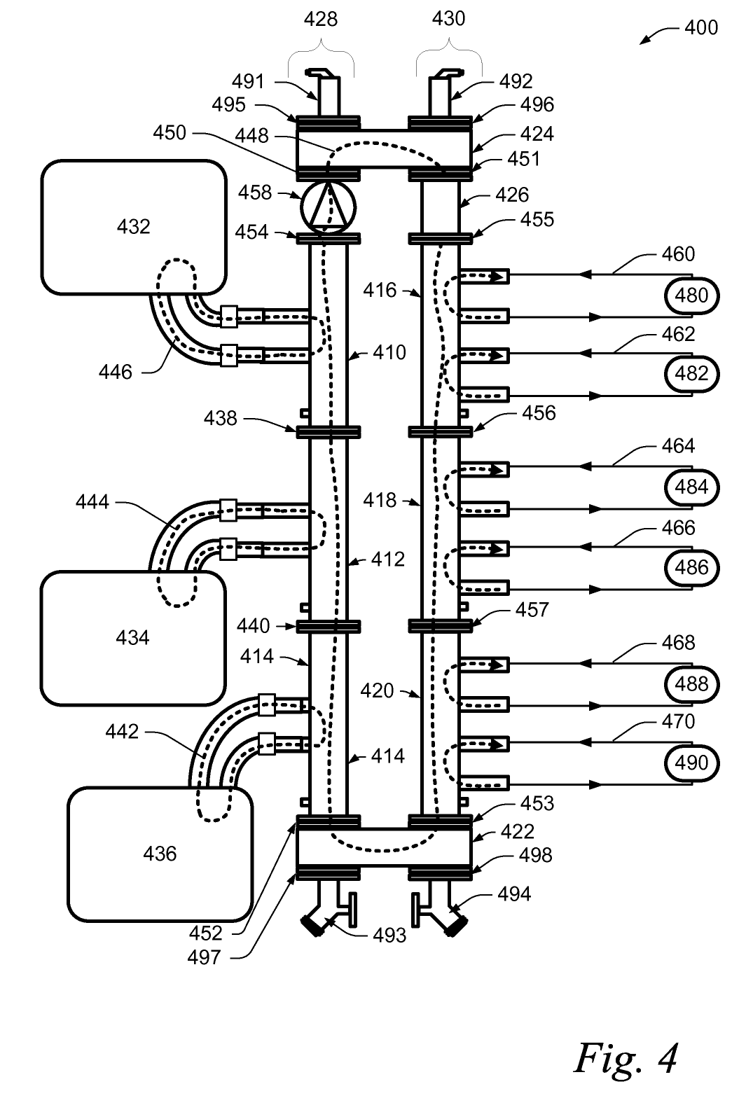

Referring to FIG. 4, a heating/cooling system 400 having a series primary loop configuration with three heat sources and six heating/cooling zones is depicted using one embodiment of Applicant's vertical manifold.

The 2-port segments 410, 412, and 414, and circulator pump 458 are releasably attached at couplings 438, 440, and 454 to form vertical manifold 428. Each 2-port segment 410, 412, and 414 are operatively connected to a heating/cooling source. To better describe the invention and for purposes of clarity only, the heating/cooling system 400 will be hereinafter described as a heating system 400. As such, the heating/cooling units 432, 434, and 436 will be described as heater 432, heater 434, and heater 436, each of which heats the heat transfer fluid.

In one embodiment, heater 436 is a conventional cast-iron boiler, heater 434 is a solar heater, and heater 432 is biomass heater. In different embodiments, heaters 432, 434, and 436 may be any combination conventional cast-iron boiler, solar heater, biomass heater, or other heater capable of transferring heat to a heat transfer liquid.

In one embodiment, heaters 432, 434, and 436 each have an internal circulator pump (not shown). The action of the circulator pumps circulates the heat transfer fluid along the paths 446, 444, and 442, respectively, in a clockwise fashion. Each port on the 2-port segments 410, 412, and 414 is spaced no father apart than 4 times the internal diameter of the segment from the other port. Such spacing is necessary for proper hydraulic separation. As such, each path 446, 444, and 442 are unaffected by the flow through the other paths and are unaffected by the flow of fluid along the length of vertical manifold 428. Additionally, each heater 432, 434, and 436 can be easily deactivated or removed from the system for maintenance while the overall heating system 400 continues to operate. This would simply require closing a valve (not shown) between each of the two ports on a given segment. Because each heater is hydraulically separated, such removal has no impact on continued performance of the heating system 400, aside the decrease in heat to the system that the removed heater provided.

The vertical manifold 428 is releasably attached to vertical manifold 430 by connectors 424 and 422 at couplings 450, 451, 452, and 453. Connectors 424 and 422 include an internal channel to allow heat transfer fluid to circulate, in this embodiment, counterclockwise through vertical manifolds 428 and 430 as shown by path 448. Vertical manifold 430 is comprised of extender 426 and three 4-port segments 416, 418, and 420 releasably attached at couplings 455, 456, and 457.

An air eliminator 491 is aligned over the vertical manifold 428 and is releasably attached to connector 424 at coupling 495. An air eliminator 492 is aligned over the vertical manifold 430 and is releasably attached to connector 424 at coupling 496. A sediment drain 493 is aligned under vertical manifold 428 and is releasably attached to connector 422 at coupling 497. A sediment drain 494 is aligned under vertical manifold 430 and is releasably attached to connector 422 at coupling 498. Air eliminators 491 and 492 are configured to allow accumulated gas to escape while retaining the heat transfer fluid. In one embodiment, the internal diameter of each segment 410, 412, 414, 426, 416, 418, and 420 are sized such that the flow rate of fluid traveling through the vertical manifolds 428 and 430 is sufficiently slow to allow particulate matter to settle to sediment drain 493 and 494 and to allow gas bubbles to rise to air eliminators 491 and 492. In one embodiment, the inner diameter each segment 410, 412, 414, 426, 416, 418, and 420 is 1.5 inches.

Each 4-port segment 416, 418, and 420 supports two heating zones each, 460, 462, 464, 466, 468, and 470, respectively. One zone is supported by the upper two ports and one zone by the lower two ports on each 4-port segment. The spacing between each port allows for hydraulic separation between the flow though the body of the segment 416, 418, and 420 and flow circulating through the adjacent ports for a zone 460, 462, 464, 466, 468, and 470. Hydraulic separation allows each zone 460, 462, 464, 466, 468, and 470 to be operated independently by pulling heat from the vertical manifold 430 as necessary. It also allows each zone 460, 462, 464, 466, 468, and 470 to operate independently of each other and allows each zone to be serviced independently without affecting the operation of the other zones.

The six heating zones 460, 462, 464, 466, 468, and 470 each support a heat transfer module 480, 482, 484, 486, 488, and 490, respectively. One or more of the zones 460, 62, 64, 66, 68, 70 may include a pump (not shown) to help circulate the heat transfer liquid through the given zone. The flow of heat transfer fluid through the loop is indicated by the broken line and arrow on each loop. The heat transfer modules 480, 482, 484, 486, 488, and 490 transfer heat out of (in the case of heating) or into (in the case of cooling) the heating/cooling system 400. In different embodiments, the heat transfer module 480, 482, 484, 486, 488, and 490 are under-floor radiant heating or cooling loops. In one embodiment, one or more of the heat transfer module 480, 482, 484, 486, 488, and 490 is an indirect fired hot water heater. In one embodiment, one or more of the heat transfer modules 480, 482, 484, 486, 488, and 490 is a radiant baseboard heater.

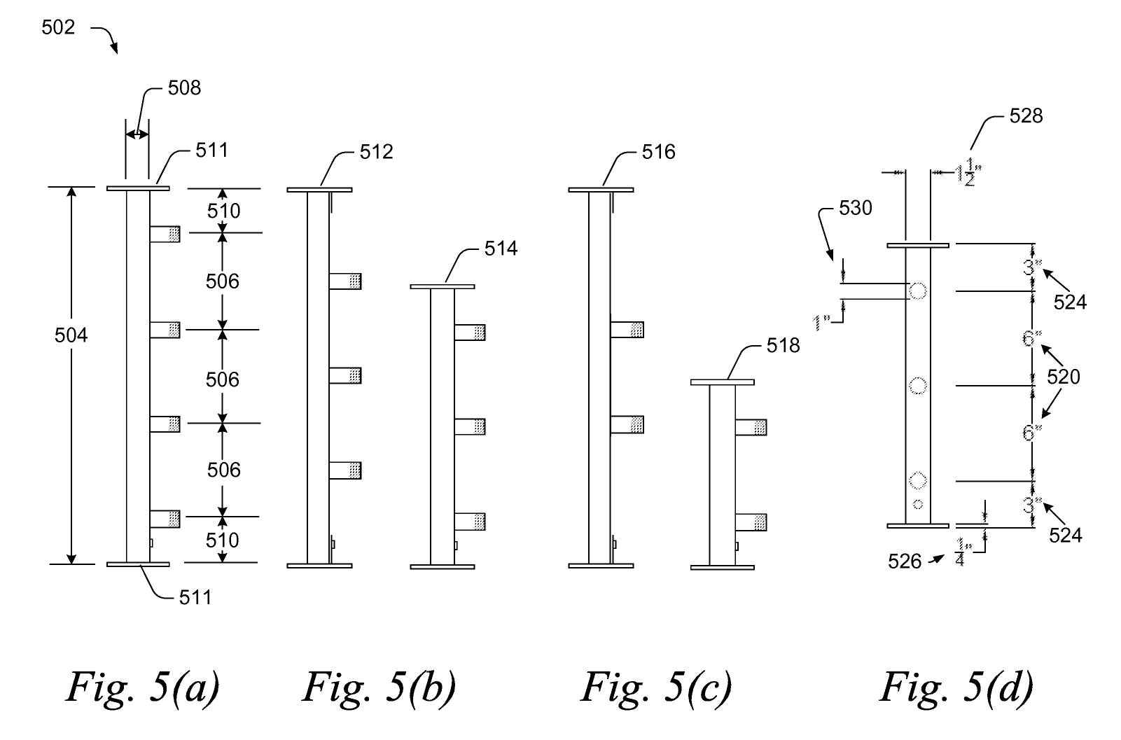

Referring to FIGS. 5(a)-5(d), the vertical segments of one embodiment of Applicant's vertical manifold is depicted. Referring to FIG. 5(a), a 4-port segment 502 is shown. The 4-port segment 502 has a length 504. Adjacent ports have a spacing 506 between the centers of the respective ports. The spacing 506 is no larger than 4 times the interior diameter 508 of the segment. The end distance 510 is measured from the center of the port to the end of the flange 511. The end distance 510 is no larger than 2 times the interior diameter 508 of the segment.

Referring to FIG. 5(b), a 3-port configuration 512 and 3-port configuration 514 is depicted. The 3-port configuration 512 has a length matching the length of 4-port segment 502. The spacing between adjacent ports is no larger than 4 times the interior diameter of the segment. Length is added evenly to each end distance to achieve the appropriate length to match the length of 4-port segment 502. The 3-port configuration 514 has a uniform spacing between adjacent ports no larger than 4 times the interior diameter of the segment and an end distance no larger than 2 times the interior diameter of the segment. The choice of the longer 3-port configuration 512 or the shorter 3-port configuration 514 is determined by the spacing requirements of the particular installation.

Referring to FIG. 5(c), a 2-port configuration 516 and 2-port configuration 518 is depicted. The 2-port configuration 516 has a length matching the length of 4-port segment 502. The spacing between adjacent ports is no larger than 4 times the interior diameter of the segment. Length is added evenly to each end distance to achieve the appropriate length to match the length of 4-port segment 502. The 2-port configuration 518 has a uniform spacing between adjacent ports no larger than 4 times the interior diameter of the segment and an end distance no larger than 2 times the interior diameter of the segment. The choice of the longer 2-port configuration 516 or the shorter 2-port configuration 518 is determined by the spacing requirements of the particular installation.

Referring to FIG. 5(d), one embodiment of a 3-port vertical segment with dimensions is depicted. In this embodiment, the interior diameter of the segment 528 is 1.5 inches. The spacing 520 between the center points of adjacent ports can be no larger than 6 inches (4×1.5=6) for allow for effective hydraulic separation between the flow through the segment and the flow through adjacent ports. The end distance 524 can be no larger than 3 inches (2×1.5=3). Because the distance between end ports on connected segments will be 6 inches (3+3), the distance between such ports is close enough to allow for effective hydraulic separation should such ports be used to circulate fluid. The interior diameter of the ports 530 is 1 inch. The width 526 of the flange is 0.25 inches to provide adequate structural support when connecting two segments.

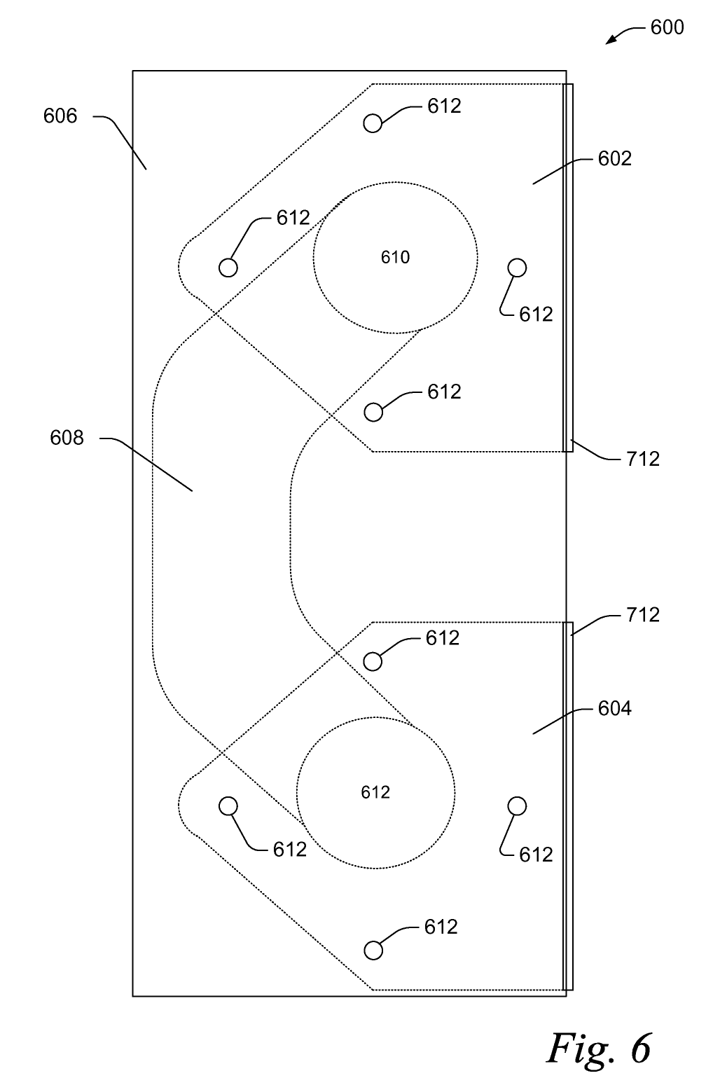

FIG. 6 depicts one embodiment of connector 600, which is another view of connectors 424 and 422 in FIG. 4. Brackets 602 and 604 are part of the couplings 450 and 451. The channel 608 creates a fluid connection between the two vertical channels 610 and 612 of vertical manifold 428 and 430, respectively. The channel is positioned to allow the connector to be secured to the vertical manifolds by holes 612, which pass entirely through connector 600. Connector 600 allows adjacent vertical columns to be operatively connected. Two connectors 600 may be used to create a series primary loop between two adjacent vertical columns, as such in FIG. 4.

FIGS. 7(a) and 7(b) depict one embodiment of a coupling 700 for securing two vertical manifold segments and the supporting bracket 702. Referring to FIG. 7(a), an expanded view of the coupling is shown with internal features shown along the cross section line 7A-7A on the bracket FIG. 7(b). The end portion 501 of a vertical manifold segment is shown with broken lines indicating the interior channel. The end portion 501 has a flange 502. The flange 502 has holes 504 (the flange 502 has two additional holes that do not fall along cross section line 7A-7A and are not shown). Similarly, the end portion 506 is shown with a flange 508 and holes 510. An O-ring 514 and a bracket 702 are disposed between end portions 501 and 506. A hole 516 (indicted by the broken lines) is formed in the center of the bracket 702. The hole 516 is sized to accept O-ring 514. The width of O-ring 514 is slightly larger than the width of bracket 702. When the coupling 700 is assembled, the O-ring 514 is compressed between 501 and 506 to create a seal against end portion 501 and end portion 506, effectively joining the inner channels of vertical manifolds 501 and 506.

In this embodiment, four bolts are used to secure the vertical manifolds 501 and 506 together. Two bolts 504 and 506 are shown. The bolts 504 and 506 each pass through the hole 504 on the end portion 501, the hole 704 on the bracket 702, and the hole 510 on the end portion 506. Two nuts 512 and 513 secures the bolts 504 and 506 and, when tightened, compresses the O-ring 514 to seal the two end portions 501 and 506. In one embodiment, the bracket 702 includes mounting bracket 712. In another embodiment, the bracket 702 does not include a mounting bracket. In one embodiment, mounting holes 714 are formed in the mounting bracket 712 to secure the mounting bracket 712 to a surface. In one embodiment, the mounting bracket 712 includes a means to secure the mounting bracket 712 to a surface without screws, thereby allowing for easier reconfiguration of the vertical manifold.

Referring to FIG. 7(b), the top view of bracket 702 is depicted. A hole 516 is formed in the mounting bracket 702. As previously mentioned, the hole 516 is sized to accept the O-ring 514. Assembly holes 704 are also formed in the mounting bracket 702. The pattern of assembly holes matches that on the flange 502 and 508 of the vertical manifold segments. The pattern also permits a vertical manifold segment to be mounting in one of four different orientations around the hole: with the ports, in this view, pointed up, to the right, down, or to the left.

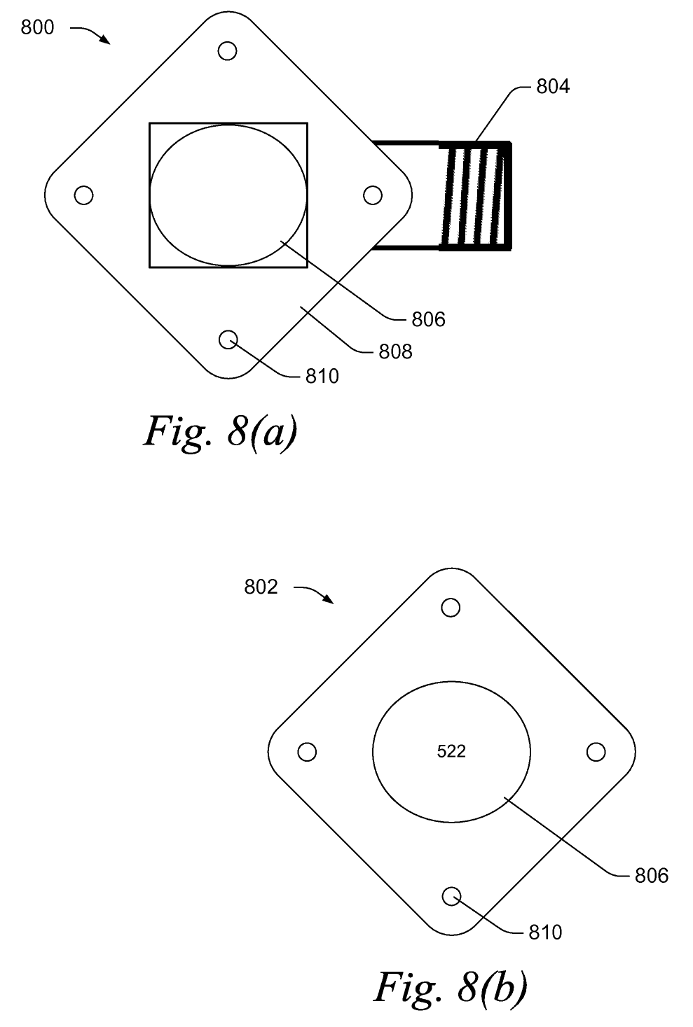

Referring to FIG. 8(a), the end view of one embodiment of a vertical segment 800 is depicted. A port with a threaded nipple 804, a flange 808 with assembly holes 810, and the channel 806, which runs the entire length of the vertical segment 800, is shown.

Referring to FIG. 8(b), another embodiment of a bracket 802 is shown. Bracket 802 is similar to the bracket 702 (shown in FIG. 7(b)) but without the mounting bracket 712. Bracket 802, allows two vertical segments to be connected in a manner similar to bracket 702, but where there is no need to secure the bracket to a surface. The bracket 802 includes a hole 812 and assembly holes 814.

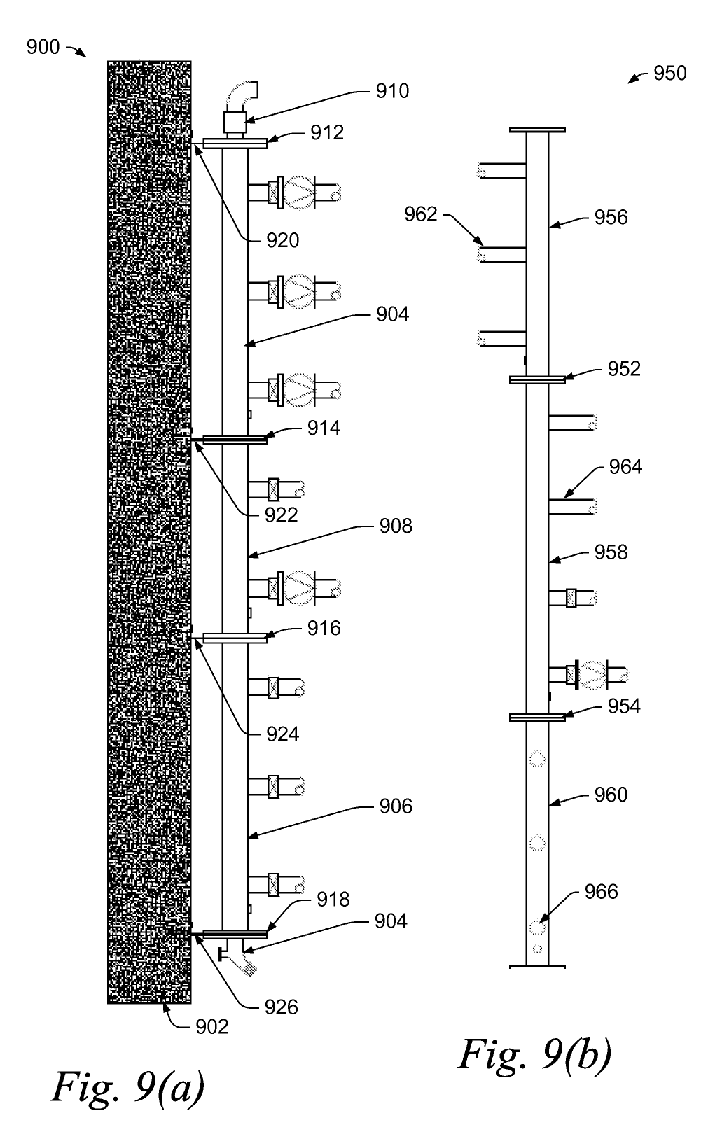

Referring to FIG. 9(a), one embodiment of the vertical manifold 900 is shown secured to a vertical surface 902. The vertical manifold 900 includes two 3 port segments 904 and 906, a 2-port segment 908, an air eliminator 910, and a sediment drain 904, which are attached by couplings 912, 914, 916, and 918. Each coupling includes a mounting bracket 712 (shown in FIGS. 7(a) and 7(b)), which allows the vertical manifold to be mounted to the vertical surface 902 at points 920, 922, 924, and 926.

Referring to FIG. 9(b), one feature of one embodiment of the vertical manifold 950 is demonstrated. As previously mentioned, one embodiment of the coupling 952 and 954 allows each vertical segment to be mounted in one of four orientations relative to a connected vertical segment. The vertical manifold 950 is secured to a wall at coupling points 952 and 954 with mounting brackets 712 (shown in FIGS. 7(a) and 7(b), but not visible in this view). The upper vertical segment 956 is configured with ports 962 pointing to the left. The middle vertical segment 958 is configured with ports 964 pointing to the right. The lower vertical segment 960 is configured with ports 966 pointing directly forward and away from the wall. In this particular embodiment, when secured to a wall, the vertical segments cannot be configured to point toward the wall due to space limitations.

Referring to FIG. 10, one method of manufacturing one embodiment of Applicant's vertical manifold is depicted. A pipe is cut to length at step 1002. In one embodiment, the pipe may be comprised of copper, brass, cross-linked polyethylene/aluminum/cross-linked polyethylene (PEX-al-PEX), polybutylene, polyethylene, or steel. Holes are formed in the pipe at step 1004. The holes are formed along the length of the pipe.

Ports are disposed in each hole at 1006. In one embodiment, the end of the port opposite that attached to the pipe has a threaded nipple. The spacing between the holes, and therefore the ports, is no farther apart than 4 times the inner diameter of the pipe. This spacing allows for hydraulic separation between liquid circulating through adjacent ports and liquid circulating through the length of the pipe.

A coupling is created on each end of the pipe at step 1008. In one embodiment, the coupling comprises a flange. In one embodiment, the coupling comprises a threaded nipple. This coupling allows the ends of two pipes to be releasably attached, allowing for easy reconfiguration.

The method repeats for the desired number of segments at step 1010.

The respective ends of multiple pipes are releasably attached at step 1012 to create a column. An air eliminator is releasably attached at the top of the column at step 1014. A sediment drain is releasably attached to the bottom of the column at step 1016. A heat transfer fluid is disposed in the column at step 1018.

A means to add heat from the heat transfer fluid is operatively attached to adjacent ports on the vertical column at step 1020. In different embodiments, for example in a heating system, such means may be a conventional cast-iron boiler, a solar heating unit, a bio mass heating unit, a geothermal heating unit, a heat pump, a gas furnace, or equivalents thereof for heating the heat transfer fluid. In other embodiments, for example in a cooling system, such means may the area to be cooled, such as tubing disposed under a residential floor to cool the floor by pulling in heat to the system.

A means to subtract heat from the heat transfer fluid is operatively attached to adjacent ports on the vertical column at step 1022. In different embodiments, for example in a cooling system, such means may be an evaporative cooler, a heat pump, or refrigeration unit, or equivalents thereof for cooling the heat transfer fluid. In other embodiments, for example in a heating system, such means may the area to be heated, such as tubing disposed under a residential floor to heat to the environment, thereby cooling the heat transfer fluid. The method ends at step 1024.

The various steps or acts in a method may be performed in the order shown, or may be performed in another order. For example, in certain implementations, individual steps recited in FIG. 10, may be combined, eliminated, or reordered.

Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods to implement the present invention.

It is understood that the examples and implementations described herein are for illustrative purposes only and that various modifications or changes in light thereof will be suggested to persons skilled in the art and are to be included within the spirit and purview of this application.

What is claimed is:

1. A manifold, comprising:
a first segment configured to vertical mount to a surface, wherein said first segment comprises:
a first end and a second end, each comprising a coupling configured to releasably attach to a second segment; and
between 2 and 4 ports disposed along the length of the first segment, wherein the spacing between adjacent ports is less than 4 times an interior diameter of the first segment; and
a second segment releasably attached to the first segment.
